(19) United States
(12) Patent Application Publication
(10) Pub. No.: US 2008/0130632 A1
(43) Pub. Date: Jun. 5, 2008

(54) Apparatus and method for making calls via internet

(75) Inventor: Jonathan Leong, Johor Bahru (MY)

Correspondence Address: BUCHANAN, INGERSOLL & ROONEY PC, POST OFFICE BOX 1404, ALEXANDRIA, VA, 22313-1404, US

(73) Assignee: e-Sky, Inc., Santa Clara, CA (US)

(21) Appl. No.: 11/974,705

(22) Filed: Oct. 15, 2007

Related U.S. Application Data
(60) Provisional application No. 60/851,843, filed on Oct. 13, 2006.

(51) Int. Cl. H04L 12/66

(52) U.S. Cl. 370/352

(57) ABSTRACT

Method for providing a connection between a plurality of communication devices coupled to an internet protocol (IP) network. The method includes the steps of: receiving a signal from a first device, the signal including the e-Num of the first device; authenticating the e-num; receiving an e-Num of a second device from the first device; and establishing a connection between the first and second devices via the IP network thereby enabling users of the first and second devices to have an audio communication through the connection. The method enables an e-Num user to make four types of phone calls: e-Num to e-Num, e-Num to public switched telephone network (PSTN), PSTN to e-Num, and PSTN to PSTN.

### CROSS REFERENCE TO RELATED APPLICATIONS

This application claims the benefit of U.S. Provisional Application No. 60/851,843, entitled “Apparatus and Method for Making Calls via Internet,” filed on Oct. 13, 2006, which is hereby incorporated herein by reference in its entirety.

### FIELD OF THE DISCLOSURE

The present invention generally relates to making phone calls via the Internet and, more particularly, to providing phone services between two communication devices each of which has a unique PC internet number.

### BACKGROUND OF THE DISCLOSURE

Traditional communication is that we use to write a letter to a recipient by writing the recipient's address on the envelope and post at the post office. Then, the postmen will deliver the ground mail to the recipient's address. After the invention of personal computer (PC) and the Internet, electronic mail (email) has become a communication method for sending files, letters, pictures, and documents free of charge. Typically, one who has a PC connected to the Internet owns at least one email account/address which corresponds to the traditional recipient address.

Telephone service is an important part of our society. As in the case of ground mail, telephone networks are beginning to move from public switched telephone network (PSTN) to an internet protocol (IP) based telephone network. Today, we can make calls through internet services, such as Voice over Internet Protocol (VoIP) free of charge or at low cost. Existing internet telephony service providers, such as Skype and Vonage, are based on the VoIP and provide phone services between two PC telephones, between a PC telephone (program) and a regular phone connected to the Internet via an Analogue Telephone Adapter (ATA), and between a PC telephone and a mobile/regular phone coupled to a PSTN. However, conventional internet telephony service providers do not provide connection services between two regular phones. Also, a user calling from a regular payphone must keep on changing his card after his airtime credit expires. Thus, there is a need for a technique for providing a phone-to-phone service as well as the PC-to-phone and PC-to-PC services with an efficient approach to payment.

### SUMMARY OF THE DISCLOSURE

In one aspect of the present invention, a method for providing a connection between a plurality of communication devices coupled to an internet protocol (IP) network, a portion of the devices being coupled to the IP network via a public switched telephone network (PSTN), each device being associated with a unique ID number, e-Num, and able to communicate audio signals to a user thereof upon connection, includes the steps of: receiving a signal from a first device in the portion, the signal including the e-Num of the first device; authenticating the e-Num; receiving an e-Num of a second device from the first device; and establishing a connection between the first and second devices via the IP network thereby enabling users of the first and second devices to have an audio communication through the connection.

In another aspect of the present invention, a method for providing a connection between a plurality of communication devices coupled to an internet protocol (IP) network, a portion of the devices being coupled to the IP network, each device being associated with a unique ID number, e-Num, and able to communicate audio signals to a user thereof upon connection, includes the steps of: receiving a signal from a first device in the portion, the signal including the e-Num of the first device; authenticating the e-Num; receiving an other signal including information of a second device from the first device; and establishing a connection between the first and second devices via the IP network thereby enabling users of the first and second devices to have an audio communication through the connection.

### BRIEF DESCRIPTION OF THE DRAWINGS

FIG. 1 is a schematic diagram of a communication system having a Multimedia Services over Internet Protocol (MOIP) platform in accordance with one embodiment of the present invention;

FIG. 2 is a schematic diagram of a communication system having a Multimedia Services over Internet Protocol (MOIP) platform in accordance with another embodiment of the present invention;

FIG. 3 shows an exemplary e-number information database of FIG. 2;

FIG. 4 is a flow chart illustrating exemplary steps to authenticate and authorize e-Num registrant to make a call in the systems of FIGS. 1 and 2;

FIG. 5 is a flow chart illustrating exemplary steps for installing an e-Num softphone on a PC and making a phone call from the PC in the systems of FIGS. 1 and 2;

FIG. 6 is a flow chart illustrating exemplary steps for making a call from a regular/mobile phone to a PC in the systems of FIGS. 1 and 2; and

FIG. 7 is a flow chart illustrating exemplary steps for making a call from a regular/mobile phone to another regular/mobile phone in the systems of FIGS. 1 and 2.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

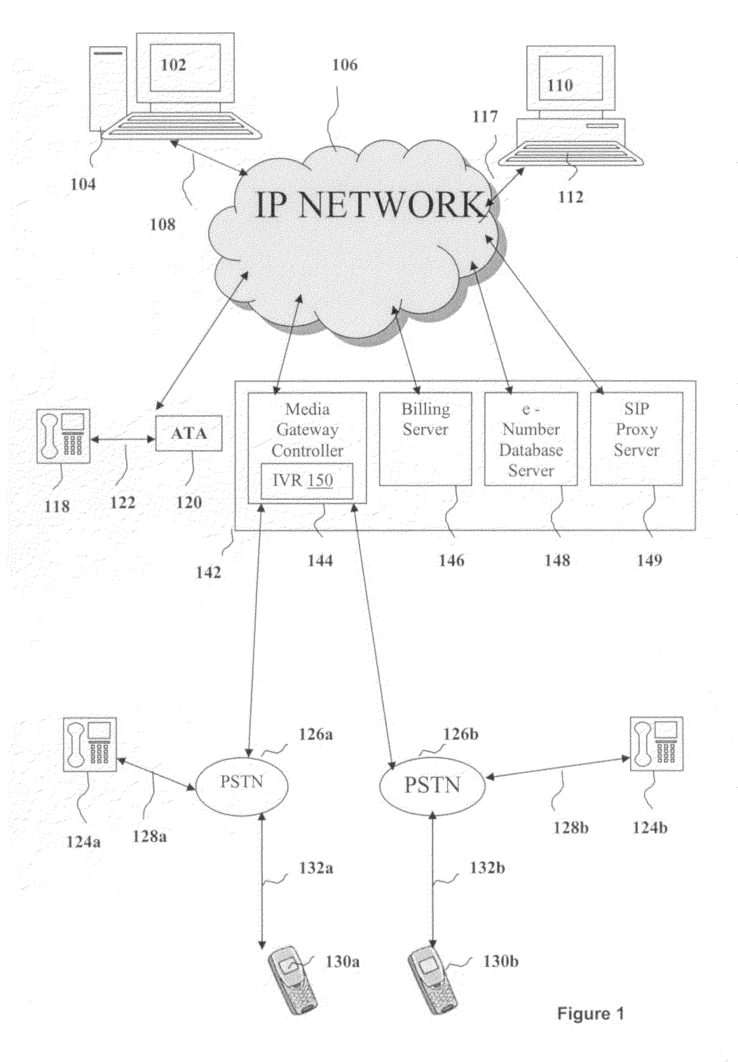

FIG. 1 is a schematic diagram of a communication system shown at 100 and having a Multimedia Services over Internet Protocol (MOIP) in accordance with one embodiment of the present invention. As depicted, the system includes one or more computers 104, 112 respectively connected to the IP network or Internet 106 via suitable connection mechanisms 108, 117, such as landlines or wireless connection. Each computer can be a desk top computer, a PC, or a local server for providing services to PCs, and for simplicity, referred to as PC hereinafter. The computers 104, 112 may include e-Num softphones or PC telephones 102, 110, wherein the PC telephone is a software that interfaces between a computer and its user and enables the user to make phone calls via the Internet. Hereinafter, the term e-Sky e-Number (or, shortly e-Num or e-Number) refers to a unique and exclusive personal number.

An e-Num is used, for instance, as a computer telephone number that identifies a PC telephone installed on a computer. An e-Num includes a global number code that starts from 878777, followed by a 9 digit personal ID number. A user can use an e-Num account anywhere in the world to make a call without notifying his physical location to the receiving party and without knowing the location of the receiving party. The user logs into the PC telephone 102 or 110 by entering personal computer telephone number that includes a personal e-Enum and password. Each computer is coupled to the Internet 106 by one of known connection techniques, such as telephone dial-up, ISDN, DSL, etc.

The system 100 also includes a regular phone 118 connected to an Analogue Telephone Adapter (ATA) 120 via a cable 122, wherein the ATA is connected to the Internet 106. The ATA 120 translates an analog signal of human voice to a digital signal. The digital signal travels over the Internet 106 and is translated back into the analog signal upon arrival at its destination, such as the computers 104, 112 or another ATA. The ATA 120 is programmed to include an e-Num. In the system 100, ATA-to-ATA communications may be free of charge. In FIG. 1, only one ATA and two PSTNs are shown for brevity. However, it should be apparent to those of ordinary skill that other suitable number of ATAs and PSTNs may be connected to the MOIP platform 142.

The system 100 further includes a Multimedia Services over Internet Protocol (MOIP) platform 142 that has a Media Gateway Controller 144, a billing server 146, an e-number database server 148, and a session initiation protocol (SIP) proxy server 149. The Media Gateway Controller 144 includes an interactive voice response (IVR) 150 and is connected to one or more PSTNs 126. Each PSTN is connected to one or more regular phones 124 via landlines 128 and one or more mobile phones 130 via suitable wireless connection mechanisms 132.

The system 100 enables an e-Num user to make PC-to-PC and ATA-to-ATA calls. The system also enables an e-Num user to make PC-to-phone, phone-to-PC, and phone-to-phone calls, where the phone is a regular or mobile phone anywhere in the world.

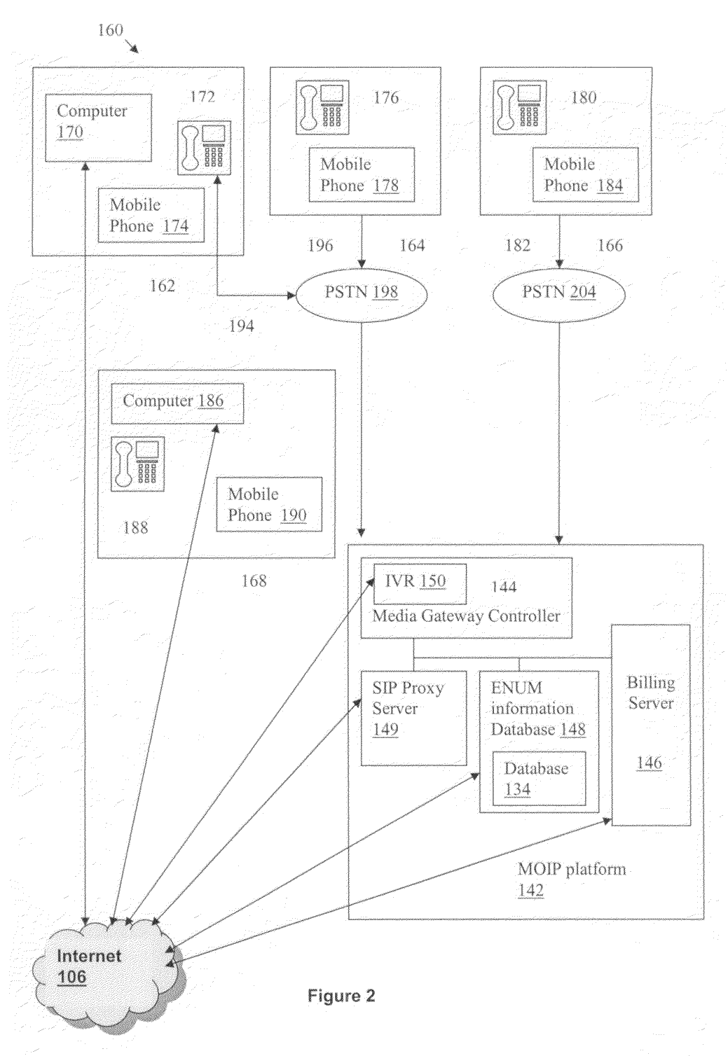

FIG. 2 is a schematic diagram of a communication system shown at 160 and having an MOIP platform 142 in accordance with another embodiment of the present invention. As depicted, the system 160 includes PSTNs 198, 204, an MOIP platform 142, Internet 106, and customer premise 162, 164, 166, and 168 connected to at least one of the Internet, MOIP platform, and PSTNs. Communication equipment, referred to as customer premise equipment (CPE) is located at each customer premise. A CPE of the premise 162 includes a fax, a computer 170 having a PC telephone, a regular phone 172, a mobile or cellular phone 174, etc. The mobile phone 174 is shown as located at the premise 162. Since a mobile phone is a mobile communication device, it does not need to be physically located at the premise 162 to operate. The regular phone 172 is connected to the PSTN 198 by a landline 194, for instance. The customer premise 168 is similar to the premise 162. The premise 164 includes a regular phone 176 and a mobile phone 178 connected to the PSTN 198. The customer premise 166 includes a regular phone 180 and a mobile or cellular phone 184 coupled to the PSTN 204 via a suitable connection mechanism 182. It is noted that the customer premise 164, 166 may also include any suitable number of communication devices, e.g., telephones, faxes, computers, etc. It is also noted that each PSTN can be connected to any suitable number of telephone service subscribers.

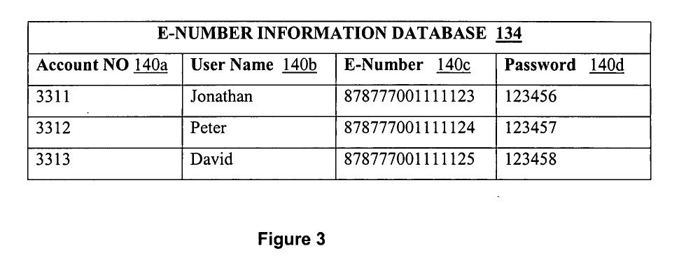

The e-number information database server 148 includes an e-number information database 134. As a variation, the database 134 may be physically located outside the MOIP platform and connected to the database server 148. Each e-Num user has at least one e-number and password and is enlisted in the database 134. FIG. 3 shows an exemplary e-number information database 134 in FIG. 2. Each row in the database 134 corresponds to an e-Num registrant. Each row includes an account number 140a, a user name 140b, an e-Number 140c, and a password 140d. For instance, the first row includes “Jonathan” as the user name, “3311” as the account number, “878777001111123” as the e-Number, and “123456” as the password E-num register and e-Number database 134 are used to store information of other countries MOIP platform which will act as the registry allowing e-Num users at different countries to communicate with each other. Each e-Number 140c is installed in the environment of a computer and used by the MOIP platform 142 during authentication and authorization.

Each account/e-number can be associated with another cell phone and regular phone. For a user account, say 878777010111777, the setting for the Forward service is available. When the recipient is busy or not available, or does not answer, the call from another e-num will be re-routed to the designated phone number: 1.408.373.3858, which is a local cell phone number. That means the e-Num user can set the e-Num to be forwarded to his oversea local phone number even if he is oversea.

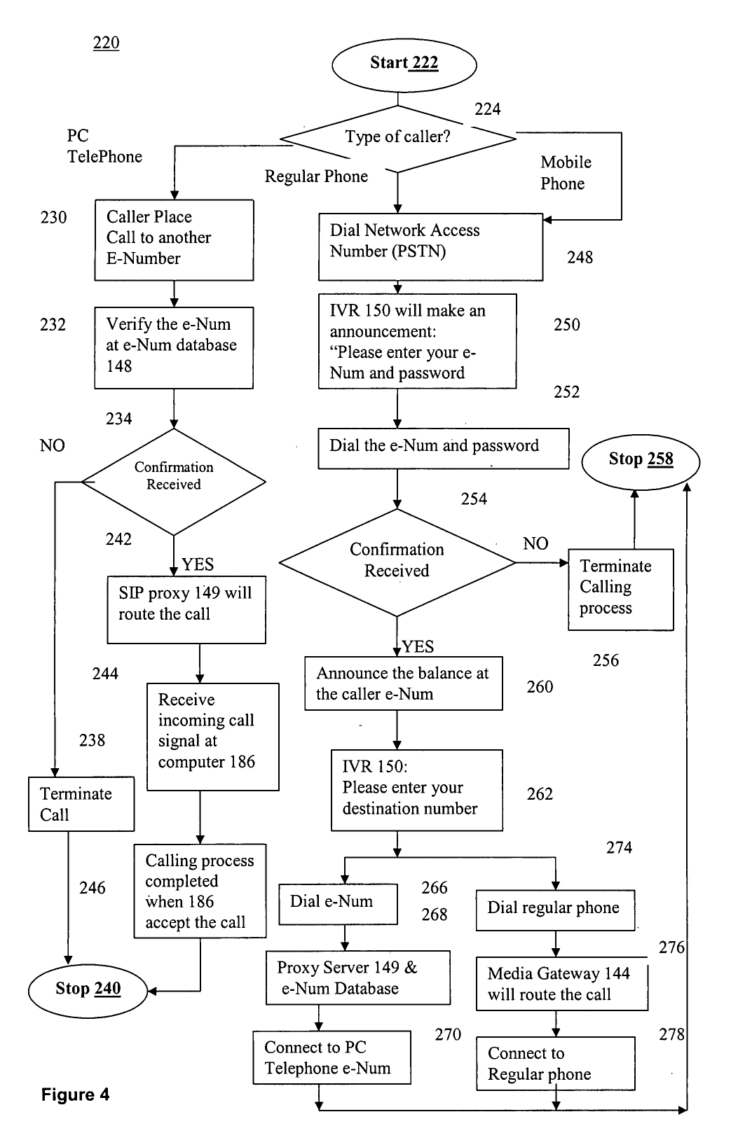

FIG. 4 is a flow chart 220 illustrating exemplary steps for authenticating and authorizing an e-Num registrant to make a call in the system 100. Hereinafter, the system 100 collectively refers to both the systems 100 and 160. The process starts at state 222. In a state 224, the type of caller device is determined. If the caller device is a PC telephone, the process proceeds to a state 230. In the state 230, the caller places a call to another e-number. For the purpose of illustration, the caller is assumed to be the PC telephone installed on the computer 170 while the recipient is a PC telephone installed on the computer 186. In a state 232, the data associated with the call is sent through the internet 106 and reach the e-number database server 148 for verification of the caller's e-Num. In a decision block 234, it is checked whether or not the current status of the recipient's status is active. More specifically, in the state 234, the system 100 receives the e-Num and password from the caller via the SIP signaling from the caller PC or ATA to the SIP proxy server 149 and e-number database server 148 and also the billing server 146. The billing server 146 checks the remaining balance of the account associated with the e-Num. Once the e-Num user account is active in the database, the system 100 will send a confirmation signal to allow the caller to make a call. If the answer to the block 234 is positive, i.e., the recipient is active, the process proceeds to a state 242. In the state 242, IP signal will be authorized by the SIP proxy server 149 (FIG. 2). The SIP proxy server 149 searches for a database entry matching the recipient's e-Num account and routes the IP signal to the recipient PC telephone in the computer 186. In a state 244, the PC telephone at the recipient computer 186 will receive the incoming call signal of the computer 170. In a state 246, the calling process is completed when the computer 186 accepts the call from the computer 170. If the answer to the block 234 is negative, i.e., the recipient is offline, the process proceeds to step 238 to terminate the call. Subsequently, the calling process ends in a state 240.

When the caller device is a regular phone, say 172, coupled to a PSTN, say 198, the caller dials a network access number in order to get connected to the system in a state 248. The network access number is connected direct to the Media Gateway controller 144. Then, a state 250, the IVR 150 will give to the caller an announcement “Please enter you e-Num and password and press a # key,” for instance. In a state 252, the caller will dial the last 9 digit of e-Num and password “001111123123456” and the dial-tone-multi-frequency (DTMF) signal will be sent from the caller's PSTN network to the media gateway controller 144 and thence routed to the SIP proxy server 149 and e-number database 134 for verification. In a decision block 254, a determination is made whether or not the e-Num and password are valid. In the state 254, the same processes as in the state 234 are performed. When a caller enters his correct e-Num and password in the state 252, the signal is send to the SIP proxy 149, e-number database 148 and also billing server 146 for verification. Once approved and verified that said caller is a valid and active e-Num user, the caller will receive the confirmation signal from the IVR 150 to allow the caller for the next step.

In the state 254, the billing server 146 also checks the balance in the account. At this point in time, the caller is at the status of e-number mode and the signal of the caller will be recognized as an e-number user mode. Upon confirmation of e-Num and password, the IVR 150 will announce the balance in the account to the caller and send a new voice prompt “Please key in your destination and press # key” in states 260 and 262. At this point, the caller can call another e-number or any regular telephone number. In a state 266, the caller dials an e-number. Then, the signal will go to the SIP proxy server 149 and e-number database server 148 to search for the e-number IP location in a state 268. In a state 270, the recipient computer with the e-Num will receive the incoming call signal from the caller. Next, the calling process stops at step 258. However, if the e-Num is associated with an ATA, say 120, the call is forwarded to a phone 118. If the caller makes a call to a regular telephone number (PSTN) in a state 274, the DTMF signal will be sent to the Media Gateway Controller 144 to route the call to the destination number in a state 276. Then, the recipient with the regular/mobile phone will receive the call in a state 278. Subsequently, the calling process stops at step 258.

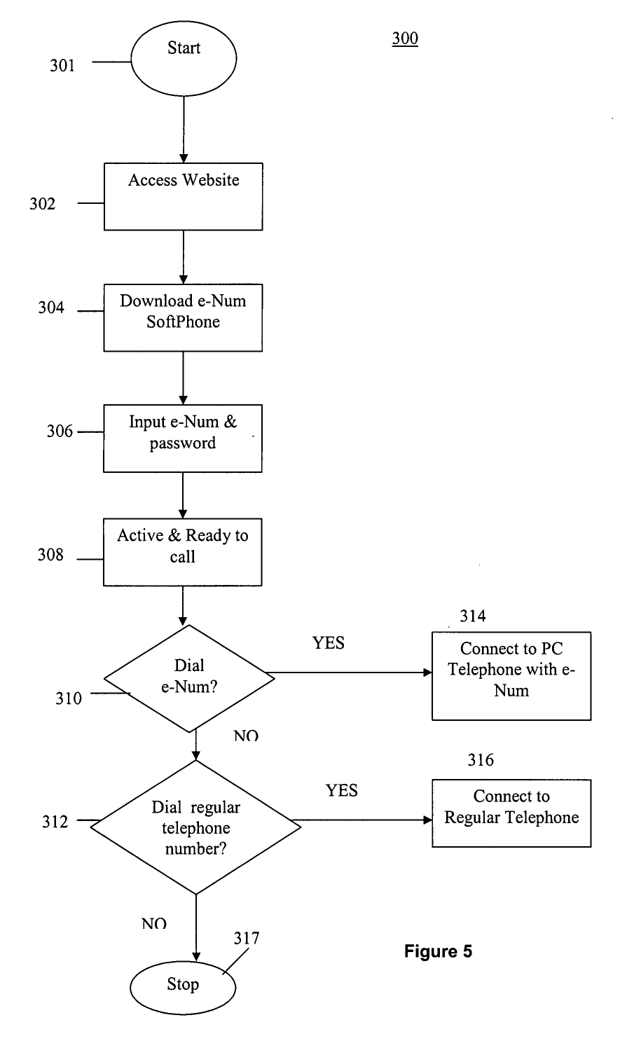

FIG. 5 is a flow chart 500 illustrating exemplary steps for installing the PC telephone 102 (FIG. 1) on a PC 104 and making a phone call from the PC telephone. The process to install the PC telephone 102 starts at step 301. In states 302 and 304, a computer user accesses a website and download the PC telephone and keep in the given e-Number and password. As a variation, the PC telephone may be obtained through any suitable computer storage medium, such as CD, memory stick, etc. At step 306, the e-Number and password are input to the system. After the authorization of billing server 146, e-number database server 148, and SIP proxy server 149, the e-Num is activated in the system to complete the installing process and the e-Num is ready to call in a state 308. In a decision block 310, it is determined whether or not the caller calls another e-Num. If the answer to the block 310 is YES, the call will be connected directly to the receiving e-Num to establish a PC-to-PC (for instance, computers 104 and 112) or PC-to-ATA (for instance, 104 and 120) connection in a state 314. It is noted that ATA 120 includes an e-Num programmed to interact with another e-Num. The caller just dials the recipient e-Num in the ATA 120 and the regular phone 118 will ring. The PC-to-PC and PC-to-ATA service may be free of charge anywhere in the world.

If the answer to the block 310 is NO, it is determined if the caller makes a call to a regular or mobile phone in another decision block 312. If answer to the block 312 is YES, a connection between the PC telephone and a regular or mobile phone anywhere in the world is established in a state 316. Otherwise, the process stops at step 317. As depicted in FIGS. 1 and 2, an e-Num user can place a call to any regular phone 124 and mobile phone 130 anywhere in the world by just dialing in the recipient regular phone. An e-Num will be routed through the Media Gateway Controller 144 to the recipient.

In the state 314, when the call is placed to an e-Num recipient. If the recipient is using the PC or ATA, he can answer the call on the spot. If he is out of his home or office, he can't answer the e-Num call. E-Num call will be forward to his mobile phone or another regular phone which is associated to this e-Num account since he can pre-set the e-Num forward service at the database shown in FIG. 3.

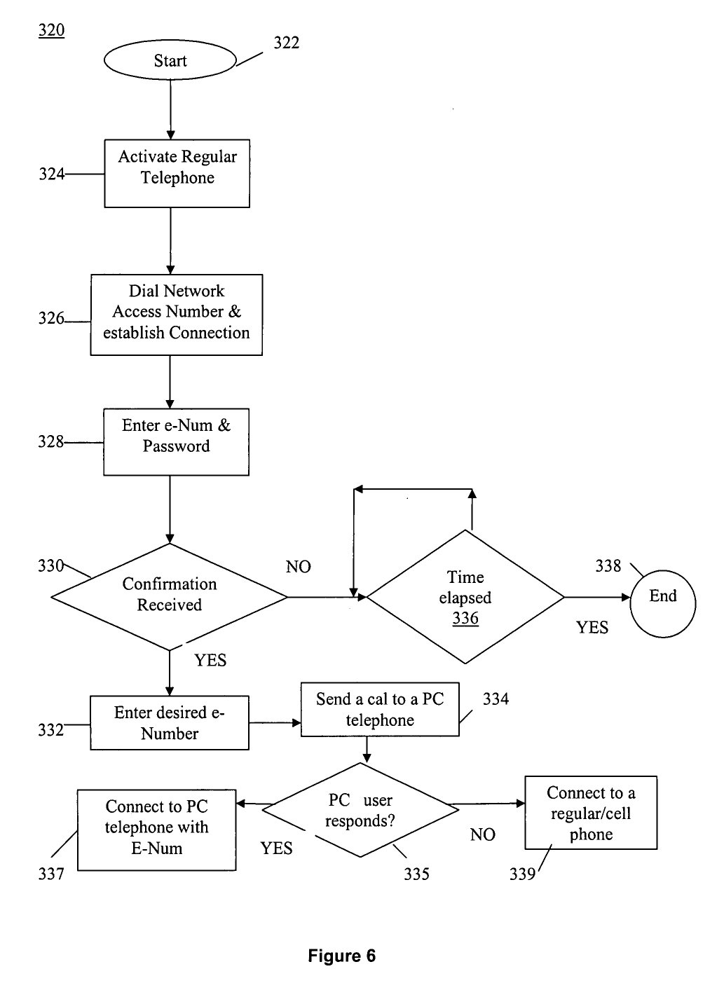

FIG. 6 is a flow chart 320 illustrating exemplary steps for making a call from a regular/mobile phone to a PC telephone in the system of FIG. 2. In states 324 and 326, the caller activates a phone and uses the telephone key pads to enter an access number of an internet calling service, which can be a local access number or a nationwide toll-free number. Typically, in the U.S., this is an eleven digit telephone number, such as 1-800-368-6872. Once the connection is established to the service, the caller enter an e-Number, say 9 digits and password with 6 digits in a state 328. Then, in a decision block 330, it is determined whether or not the authentication/confirmation of the billing server 146, e-number database server 148, and SIP proxy server 149 is received. If the answer to the block 330 is YES, the caller can dial the recipient e-Num in a state 332 and a calling signal is sent to a corresponding PC telephone in a state 334. Then, in a state 335, it is determined whether the user of the PC telephone answers the call. If answer to the block 335 is YES, a connection between the caller's regular/mobile phone and e-Num of a receiving PC is established in a state 337. This phone-to-PC call is a breakthrough in the telecommunication industry since a user can use any regular/mobile phone to talk to any e-Num user by using e-Num to e-Num calling methodology. This phone-to-PC call can be free of charge. If answer to the block 335 is NO, the call is forwarded to a regular/cell phone in a state 339. If the answer to the block 330 is NO, it is checked if a preset time interval has elapsed in another decision block 336. If the answer to the block 336 is positive, the process ends at step 338.

It is noted that the caller can use an e-Num as a calling card and the user can keep on using the same e-Num account anywhere as long as the service provider have the network access number available. It is also noted that the state 316 and 334 respectively represent PC-to-phone and phone-to-PC connections. The system 100 provides new types of communications, eNum-to-PSTN and PSTN-to-eNum, and combines the traditional phone services with internet protocol (IP) signaling.

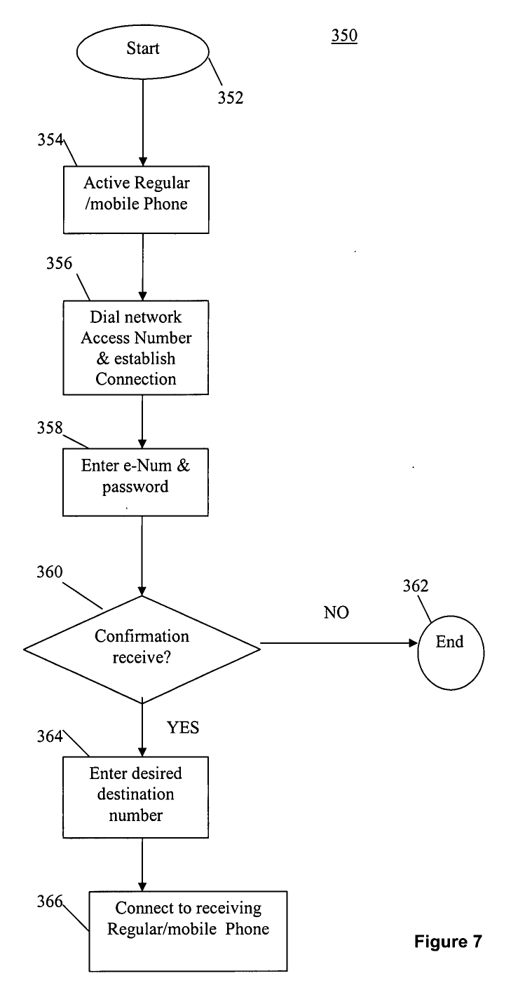

FIG. 7 is a flow chart 350 illustrating exemplary steps for making a call from a regular/mobile phone to another regular/mobile phone in the system 100. In states 354 and 356, the user activates a regular/mobile phone and uses the telephone key pads to enter an access number of an internet calling service, which can be a local access number or a nationwide toll-free number. Typically, in the U.S., this is an eleven digit telephone number, such as 1-800-368-6872. Once the connection is established to the service, the caller enters an e-Number, say 9 digits and password with 6 digits in a state 358. Then, in a decision block 360, it is determined whether or not the authentication/confirmation of the billing server 146, e-number server 148, and SIP proxy server 149 is received. If the answer to the block 360 is YES, the caller can dial the recipient regular/mobile phone number in state 364 and a connection between a regular/mobile phone and another regular/mobile phone is established in a state 366. If the answer to the block 360 is NO, the calling process stops at step 362. In the state 366, the billing server 146 can calculate the call charge based on a predetermined rate and the connection time. This is like an international calling card which also allows an e-Num caller to call to anyone in the world even the recipient may not have an e-Num account.

It is noted that the two phones connected in the step 366 can be remotely separated, i.e., an e-Num user can make an international call to another e-Num user. This provides convenience to the user since he does not need to dial pin codes specific to countries or states. Also, the user can have voice conferencing call by using his cell or home phone.

E-Sky e-num is based on e-sky Multimedia services over Internet Protocol platform (e-sky MOIP) and used for authenticating/authorizing users to register their computers in the e-Sky e-Num database 134.

An e-Num is a unique and exclusive computer telephone number that identifies the PC telephone installed on a computer and is not associated with any regular telephone number. Currently, email is used to exchange information between two parties without knowing their exact physical locations insofar as each party has a unique email address. Likewise, e-Num is used to make phone calls between two PC telephones without knowing their exact locations insofar as each party has a unique e-Num. As such, each e-Num does not include any country code or area code to identify where the user is. The Multimedia Services over Internet Protocol (MOIP) platform 142 manages the global e-Num registry, issues e-Nums and updates the e-Number database 134.

E-Sky e-Num can be considered as a protocol that converges the international standard for telephone numbering sanctioned by the International Telecommunication Union (ITU), i.e., E.164, with Internet networks by using a technique based on the Domain Name Server (DNS) of the Internet. E-Num is described in Internet Engineering Task Force (IETF) document RFC 2916, which is an approved protocol document that discusses the use of DNS for the storage of telephone numbers and available services connected to a telephone number.

E-Num is implemented by using E.164 numbers and the DNS. E.164 is an accepted standard that is used throughout the world for telephone numbers, and the DNS includes the ability to correlate alphanumeric information with IP addresses. Currently, DNS is used to correlate webpage addresses with their corresponding Internet Protocol (IP) addresses, i.e., the DNS allows user computers to find website servers over the Internet using easy to remember website addresses instead of complicated Internet addresses. E.164 numbers, like the website names, remain relatively static requiring relatively infrequent updates, e.g., as individual service subscribers change their telephone or internet services.

A fully qualified E.164 number will now be described. An E.164 number includes a country code, an area or city code, and a phone number. The ITU issues country codes to sovereign nations, e.g., the United States has a country code of “1.” Area or city code, and phone numbers are administered by the sovereign nations through local telecommunications regulatory agencies. For example, a fully qualified E.164 number for the phone number, 555-1234, in Washington, D.C. (area code 202) in the United States would be +1-202-555-1234 The “+” indicates the number is a fully qualified E.164 number.

E-Num addresses the challenges discussed above in regard to the VoIP service and other services while providing telephone customers with many benefits. E-Num enables companies to offer a wide range of IP-based services for communicating with another person when the user knows only a telephone number or has access to only a telephone keypad. The user is allowed to access these IP-based services and resources from Internet-aware telephones, ordinary telephones connected to Internet gateways or proxy services, and/or other devices coupled to the Internet where input is limited to numeric digits. E-Num enables users to specify their preferences for receiving incoming communications, and gives greater user control over communications. For example, a user can set up voice mail preferences or can input a destination phone number in a call forwarding service.

Since e-Sky e-Num can offer different types of services, e-Sky e-Num has a wide range of potential customers including residential and business customers. Just like email accounts, an e-Num account can be used to identify our presence in the cyber world. E-Num can be applied for not only the PC telephone services, but also the future multimedia services, like video, data, finance, TV, and music. The same e-Num account can be used for all these multimedia applications.

Since the concept of e-Sky e-Num is not tied up with other local telephonic service, each call does not require the conventional steps for authenticating/authorizing the user. Customer information is registered and stored in the e-Num database. The e-Num protocol works in the following manner. Once an e-Num is entered, it is translated into an Internet address according to the following steps: 1) The phone number is translated into a fully qualified E.164 number by adding the city (or area) and country code. For example, a user dials +878777-001-555-123 as an e-Num, where “878777” represents the global telephone number code, “001” represents Tier 1 operator, “555” represents the city or area distributor, and “+” indicates that the number is a fully qualified E.164 number. 2) All characters are removed except for the digits. For example, +878777-001-555-123 becomes 878777001555123. 3) The order of the digits is reversed. For example, 878777001555123 becomes 321555100777878. 4) Dots are placed between each digit. For example, 321555100777878 becomes 3.2.1.5.5.5.1.0.0.7.7.7.8.7.8. 5) The domain “E.164.arpa” is appended to the end. For example: 3.2.1.5.5.5.1.0.0.7.7.7.8.7.8. becomes 3.2.1.5.5.5.1.0.0.7.7.7.8.7.8.e164.arpa.

E-Num then issues a DNS query on this domain. Once the authoritative name server is found, e-Num retrieves relevant NAPTR Resource records from an e-Num database and will perform according to the user's registered services for that number.

It should be understood, of course, that the foregoing relates to exemplary embodiments of the invention and that modifications may be made without departing from the spirit and scope of the invention as set forth in the following claims.

What is claimed is:

1. A method for providing a connection between a plurality of communication devices coupled to an internet protocol (IP) network, a portion of the devices being coupled to the IP network via a public switched telephone network (PSTN), each said device being associated with a unique ID number, e-Num, and able to communicate audio signals to a user thereof upon connection, the method comprising:
receiving a signal from a first device in the portion, the signal including the e-Num of the first device;
authenticating the e-Num;
receiving an e-Num of a second device from the first device; and
establishing a connection between the first and second devices via the IP network thereby enabling users of the first and second devices to have an audio communication through the connection.

2. A method as recited in claim 1, further comprising, prior to receiving an e-Num of a second device:
sending to the first device a voice prompt requesting an input of the e-Num of the second device.

3. A method as recited in claim 1, wherein the step of authenticating includes:
checking if the e-Num of the first device is in an e-number database; and
checking a remaining balance associated with the e-Num of the first device.

4. A method as recited in claim 3, further comprising, prior to establishing a connection:
announcing the remaining balance to the first device.

5. A method as recited in claim 1, wherein each of the devices includes one selected from the group consisting of a mobile phone and a regular phone connected to a PSTN via a landline.

6. A method as recited in claim 1, wherein each e-Num includes a string of numbers arranged according to an international standard for telephone numbering sanctioned by the International Telecommunication Union.

7. A method for providing a connection between a plurality of communication devices coupled to an internet protocol (IP) network, a portion of the devices being coupled to the IP network, each said device being associated with a unique ID number, e-Num, and able to communicate audio signals to a user thereof upon connection, the method comprising:
receiving a signal from a first device in the portion, the signal including the e-Num of the first device;
authenticating the e-Num;
receiving an other signal including information of a second device from the first device; and
establishing a connection between the first and second devices via the IP network thereby enabling users of the first and second devices to have an audio communication through the connection.

8. A method as recited in claim 7, further comprising, prior to receiving the other signal:
sending to the first device a voice prompt requesting an input of the information.

9. A method as recited in claim 7, wherein the step of authenticating includes:
checking if the e-Num of the first device is in an e-number database; and
checking a remaining balance associated with the e-Num of the first device.

10. A method as recited in claim 9, further comprising, prior to establishing a connection:
announcing the remaining balance to the first device.

11. A method as recited in claim 7, wherein the information includes an e-Num of a softphone in the second device and the step of establishing a connection includes:
searching for an Internet Protocol (IP) location of the second device;
sending a calling signal to the second device; and
if the softphone answers the calling signal,
connecting the softphone to the first device, otherwise,
forwarding the calling signal to a phone associated with the e-Num of the second device; and
connecting the first device to the phone.

12. A method as recited in claim 11, wherein the phone includes one selected from the group consisting of a mobile phone and a regular phone connected to a public switched telephone network (PSTN) via a landline.

13. A method as recited in claim 7, wherein the information includes an e-Num of the second device having an Analogue Telephone Adapter (ATA).

14. A method as recited in claim 7, wherein the second device includes one selected from the group consisting of a mobile phone and a regular phone connected to a public switched telephone network (PSTN) via a landline and the information includes a phone number of the second device.

15. A method as recited in claim 7, wherein each e-Num includes a string of numbers arranged according to an international standard for telephone numbering sanctioned by the International Telecommunication Union.
